(19) United States
(12) Patent Application Publication
(10) Pub. No.: US 2014/0218269 A1
(43) Pub. Date: Aug. 7, 2014

(54) MODULAR FRAME CONSTRUCTION FOR HEAD MOUNTABLE DISPLAY

(71) Applicant: Google Inc., (US)

(72) Inventors: Peter Michael Cazalet, Campbell, CA (US); Joseph John Hebenstreit, San Francisco, CA (US)

(73) Assignee: Google Inc.,, Mountain View, CA (US)

(21) Appl. No.: 13/762,146

(22) Filed: Feb. 7, 2013

(51) Int. Cl. G02B 27/01

(52) U.S. Cl. CPC G02B 27/0176
USPC 345/8

(57) ABSTRACT

A wearable device assembly includes a device module having a component housing with a display configured to present information to the user, an auxiliary housing unit remote from the component housing, and a connecting member extending between the housing unit and the auxiliary housing unit. The device also includes a head retention structure having a center support with a nosepiece extending therefrom, a first side arm extending from the center frame support on a first side thereof, and an attachment arm extending from the center support on a second side thereof. The device module and the head retention structure are configured for releasable assembly together by removably attaching a first attachment feature on the connecting arm with the second attachment feature on the retention member. When assembled together, the device assembly is wearable on the head of the user.

### BACKGROUND

Unless otherwise indicated herein, the materials described in this section are not prior art to the claims in this application and are not admitted to be prior art by inclusion in this section.

Computing devices such as personal computers, laptop computers, tablet computers, cellular phones, and countless types of Internet-capable devices are increasingly prevalent in numerous aspects of modern life. Over time, the manner in which these devices are providing information to users is becoming more intelligent, more efficient, more intuitive, and/or less obtrusive. The trend toward miniaturization of computing hardware, peripherals, as well as of sensors, detectors, and image and audio processors, among other technologies, has helped open up a field sometimes referred to as “wearable computing.” In the area of image and visual processing and production, in particular, it has become possible to consider wearable displays that place a graphic display close enough to a wearer's (or user's) eye(s) such that the displayed image appears as a normal-sized image, such as might be displayed on a traditional image display device. The relevant technology may be referred to as “near-eye displays.”

Wearable computing devices with near-eye displays may also be referred to as “head-mountable displays”, “head-mounted displays,” “head-mounted devices,” or “head-mountable devices.” A head-mountable display places a graphic display or displays close to one or both eyes of a wearer. To generate the images on a display, a computer processing system may be used. Such displays may occupy a wearer's entire field of view, or only occupy part of wearer's field of view. Further, head-mounted displays may vary in size, taking a smaller form such as a glasses-style display or a larger form such as a helmet, for example.

Emerging and anticipated uses of wearable displays include applications in which users interact in real time with an augmented or virtual reality. Such applications can be mission-critical or safety-critical, such as in a public safety or aviation setting. The applications can also be recreational, such as interactive gaming. Many other applications are also possible. Other personal image displays can be what is referred to as a heads-up display, wherein the image is displayed on, in, or through a transparent display that superimpose the displayed image over a view of the surrounding environment. These allow the user to view the image presented by the display simultaneously with their surroundings. Such devices, however, can have many limitations, including in their fit and comfort to their wearers as well as limited functionality.

### BRIEF SUMMARY

An aspect of the present disclosure relates to a wearable device assembly configured to be worn on the head of a user. The device includes a device module having a component housing with a display configured to present information to the user, an auxiliary housing unit remote from the component housing, and a connecting member extending between the housing unit and the auxiliary housing unit. The connecting member includes a first attachment structure on a surface thereof. The device also includes a head retention structure having a center support with a nosepiece extending therefrom, a first side arm extending from the center frame support on a first side thereof, and an attachment arm extending from the center support on a second side thereof. The attachment arm includes a second attachment structure that is configured to mate with the first attachment structure. The device module and the head retention structure are configured for releasable assembly together by removably attaching the first attachment feature with the second attachment feature, and when assembled together, the device assembly is wearable on the head of the user with the module positioned on a first side of the head with the display adjacent an eye of the user, the side arm positioned on a second side of the head, and the nosepiece contacting the nose of the user.

Another aspect of the present disclosure relates to a retention member for use with a personal display module that has a display configured to present information to a user, a housing unit remote from the display, and a connecting member extending at least partially between the housing unit and the display. The retention member includes a center support, a first side arm extending from the center support on a first side thereof, and an attachment arm extending from the center support on a second side thereof. The attachment arm includes a first attachment structure configured to releasably attach with a second attachment structure included along a surface of the connecting member of the personal display module. The releasable attachment between the first attachment structure and the second attachment structure removably secures the retention member to the personal display module such that the resulting assembly is wearable on the head of a user with the display of the module positioned adjacent an eye of the user.

Another aspect of the present disclosure relates to a personal display module including a component housing having a display configured to present information to the user, an auxiliary housing unit remote from the component housing, and a connecting member extending between the housing unit and the extension arm. The connecting member includes a first attachment structure on a surface thereof. The personal display module is configured to removably attach with a retention member at the first attachment structure so as to be wearable on the head of the user with the module positioned on a first side of the head with the display adjacent an eye of the user.

### BRIEF DESCRIPTION OF THE DRAWINGS

FIG. 1A illustrates a wearable computing system according to an example embodiment;

FIG. 1B illustrates an alternate view of the wearable computing device illustrated in FIG. 1A;

FIG. 1C illustrates another wearable computing system according to an example embodiment;

FIG. 1D illustrates another wearable computing system according to an example embodiment;

FIGS. 2 and 3 show a wearable computer device according to an embodiment of the disclosure;

FIGS. 4 and 5 show a front elevation view and a side elevation view of the device of FIG. 2 being worn by a user;

FIG. 6 shows the device of FIGS. 4 and 5 in an adjusted configuration thereof;

FIG. 7 shows the device of FIG. 2 according to a modular configuration thereof in a disassembled state;

FIG. 8 sows the device of FIG. 7 in a disassembled state with additional modular structures;

FIGS. 9A and 9B show detail views of components of an attachment mechanism that can be used in attaching components of the modular configuration of the device of FIGS. 7 and 8;

FIG. 10 shows a further detail view of components of the attachment mechanism of FIGS. 9A and 9B; and

FIG. 11 shows a wearable computer device with an alternative modular configuration according to another aspect of the disclosure.

### DETAILED DESCRIPTION

Example methods and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. In the following detailed description, reference is made to the accompanying figures, which form a part thereof. In the figures, similar symbols typically identify similar components, unless context dictates otherwise. Other embodiments may be utilized, and other changes may be made, without departing from the spirit or scope of the subject matter presented herein.

The example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

Systems and devices in which example embodiments may be implemented will now be described in greater detail. In general, an example system may be implemented in or may take the form of a wearable computer (also referred to as a wearable computing device). In an example embodiment, a wearable computer takes the form of or includes a head-mountable display (HMD), which may also be referred to as a head-mounted device.

An example system may also be implemented in or take the form of other devices, such as a mobile phone, among other possibilities. Further, an example system may take the form of non-transitory computer readable medium, which has program instructions stored thereon that are executable by at a processor to provide the functionality described herein. An example system may also take the form of a device such as a wearable computer or mobile phone, or a subsystem of such a device, which includes such a non-transitory computer readable medium having such program instructions stored thereon.

An HMD may generally be any display device that is capable of being worn on the head and places a display in front of one or both eyes of the wearer. An HMD may take various forms such as a helmet or eyeglasses. As such, references to “eyeglasses” or a “glasses-style” HMD should be understood to refer to an HMD that has a glasses-like frame so that it can be worn on the head. Further, example embodiments may be implemented by or in association with an HMD with a single display or with two displays, which may be referred to as a “monocular” HMD or a “binocular” HMD, respectively.

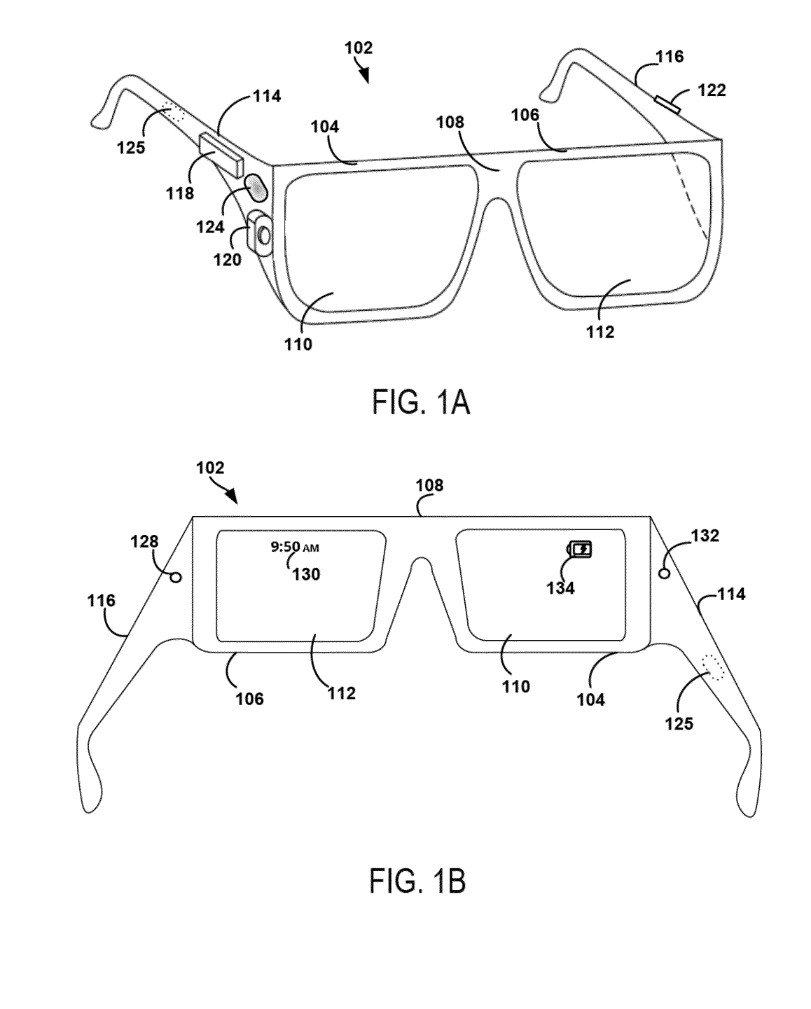

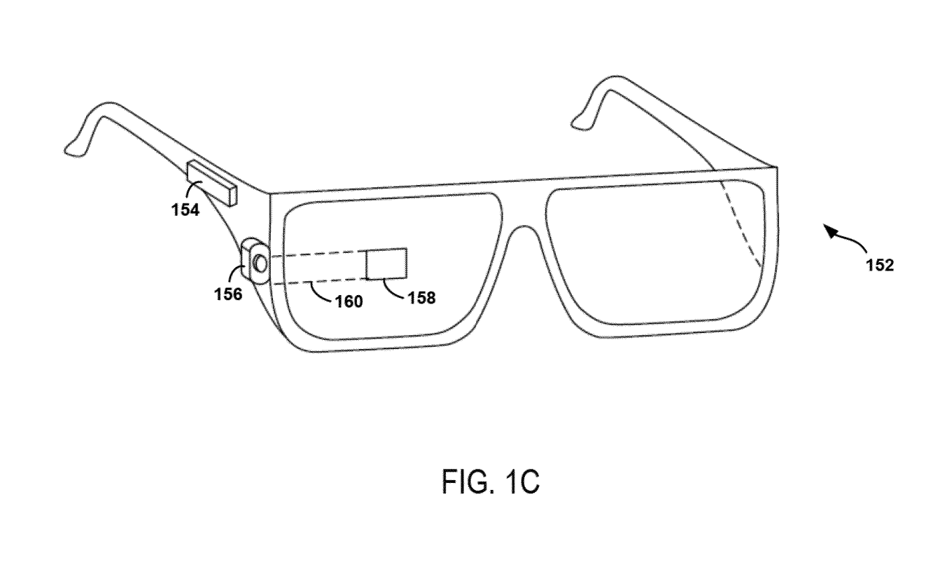

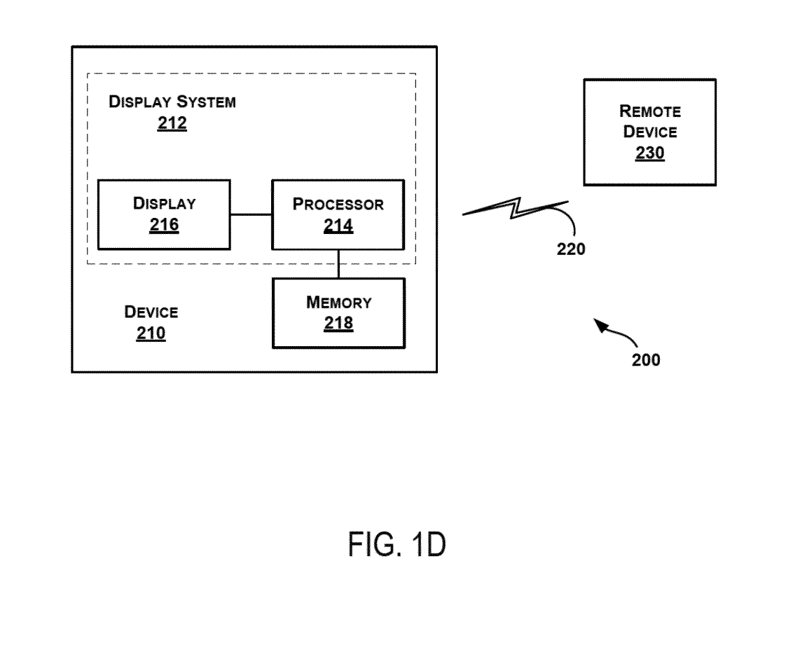

FIG. 1A illustrates a wearable computing system according to an example embodiment. In FIG. 1A, the wearable computing system takes the form of a head-mountable device (HMD) 102. However, example systems and devices may take the form of or be implemented within or in association with other types of devices. As illustrated in FIG. 1A, the HMD 102 includes frame elements including lens-frames 104, 106 and a center frame support 108, lens elements 110, 112, and extending side-arms 114, 116. The center frame support 108 and the extending side-arms 114, 116 are configured to secure the HMD 102 to a user's face via a user's nose and ears, respectively.

Each of the frame elements 104, 106, and 108 and the extending side-arms 114, 116 may be formed of a solid structure of plastic and/or metal, or may be formed of a hollow structure of similar material so as to allow wiring and component interconnects to be internally routed through the HMD 102. Other materials may be possible as well.

One or more of each of the lens elements 110, 112 may be formed of any material that can suitably display a projected image or graphic. Each of the lens elements 110, 112 may also be sufficiently transparent to allow a user to see through the lens element. Combining these two features of the lens elements may facilitate an augmented reality or heads-up display where the projected image or graphic is superimposed over a real-world view as perceived by the user through the lens elements.

The extending side-arms 114, 116 may each be projections that extend away from the lens-frames 104, 106, respectively, and may be positioned behind a user's ears to secure the HMD 102 to the user. The extending side-arms 114, 116 may further secure the HMD 102 to the user by extending around a rear portion of the user's head. Additionally or alternatively, for example, the HMD 102 may connect to or be affixed within a head-mounted helmet structure. Other configurations for an HMD are also possible.

The HMD 102 may also include an on-board computing system 118, an image capture device 120, a sensor 122, and a finger-operable touch pad 124. The on-board computing system 118 is shown to be positioned on the extending side-arm 114 of the HMD 102; however, the on-board computing system 118 may be provided on other parts of the HMD 102 or may be positioned remote from the HMD 102 (e.g., the on-board computing system 118 could be wire- or wirelessly-connected to the HMD 102). The on-board computing system 118 may include a processor and memory, for example. The on-board computing system 118 may be configured to receive and analyze data from the image capture device 120 and the finger-operable touch pad 124 (and possibly from other sensory devices, user interfaces, or both) and generate images for output by the lens elements 110 and 112.

The image capture device 120 may be, for example, a camera that is configured to capture still images and/or to capture video. In the illustrated configuration, image capture device 120 is positioned on the extending side-arm 114 of the HMD 102; however, the image capture device 120 may be provided on other parts of the HMD 102. The image capture device 120 may be configured to capture images at various resolutions or at different frame rates. Many image capture devices with a small form-factor, such as the cameras used in mobile phones or webcams, for example, may be incorporated into an example of the HMD 102.

Further, although FIG. 1A illustrates one image capture device 120, more image capture device may be used, and each may be configured to capture the same view, or to capture different views. For example, the image capture device 120 may be forward facing to capture at least a portion of the real-world view perceived by the user. This forward facing image captured by the image capture device 120 may then be used to generate an augmented reality where computer generated images appear to interact with or overlay the real-world view perceived by the user.

The sensor 122 is shown on the extending side-arm 116 of the HMD 102; however, the sensor 122 may be positioned on other parts of the HMD 102. For illustrative purposes, only one sensor 122 is shown. However, in an example embodiment, the HMD 122 may include multiple sensors. For example, an HMD 102 may include sensors 102 such as one or more gyroscopes, one or more accelerometers, one or more magnetometers, one or more light sensors, one or more infrared sensors, and/or one or more microphones. Other sensing devices may be included in addition or in the alternative to the sensors that are specifically identified herein.

The finger-operable touch pad 124 is shown on the extending side-arm 114 of the HMD 102. However, the finger-operable touch pad 124 may be positioned on other parts of the HMD 102. Also, more than one finger-operable touch pad may be present on the HMD 102. The finger-operable touch pad 124 may be used by a user to input commands. The finger-operable touch pad 124 may sense at least one of a pressure, position and/or a movement of one or more fingers via capacitive sensing, resistance sensing, or a surface acoustic wave process, among other possibilities. The finger-operable touch pad 124 may be capable of sensing movement of one or more fingers simultaneously, in addition to sensing movement in a direction parallel or planar to the pad surface, in a direction normal to the pad surface, or both, and may also be capable of sensing a level of pressure applied to the touch pad surface. In some embodiments, the finger-operable touch pad 124 may be formed of one or more translucent or transparent insulating layers and one or more translucent or transparent conducting layers. Edges of the finger-operable touch pad 124 may be formed to have a raised, indented, or roughened surface, so as to provide tactile feedback to a user when the user's finger reaches the edge, or other area, of the finger-operable touch pad 124. If more than one finger-operable touch pad is present, each finger-operable touch pad may be operated independently, and may provide a different function.

In a further aspect, HMD 102 may be configured to receive user input in various ways, in addition or in the alternative to user input received via finger-operable touch pad 124. For example, on-board computing system 118 may implement a speech-to-text process and utilize a syntax that maps certain spoken commands to certain actions. In addition, HMD 102 may include one or more microphones via which a wearer's speech may be captured. Configured as such, HMD 102 may be operable to detect spoken commands and carry out various computing functions that correspond to the spoken commands.

As another example, HMD 102 may interpret certain head-movements as user input. For example, when HMD 102 is worn, HMD 102 may use one or more gyroscopes and/or one or more accelerometers to detect head movement. The HMD 102 may then interpret certain head-movements as being user input, such as nodding, or looking up, down, left, or right. An HMD 102 could also pan or scroll through graphics in a display according to movement. Other types of actions may also be mapped to head movement.

As yet another example, HMD 102 may interpret certain gestures (e.g., by a wearer's hand or hands) as user input. For example, HMD 102 may capture hand movements by analyzing image data from image capture device 120, and initiate actions that are defined as corresponding to certain hand movements.

As a further example, HMD 102 may interpret eye movement as user input. In particular, HMD 102 may include one or more inward-facing image capture devices and/or one or more other inward-facing sensors (not shown) that may be used to track eye movements and/or determine the direction of a wearer's gaze. As such, certain eye movements may be mapped to certain actions. For example, certain actions may be defined as corresponding to movement of the eye in a certain direction, a blink, and/or a wink, among other possibilities.

HMD 102 may also include a speaker 125 for generating audio output. In one example, the speaker could be in the form of a bone conduction speaker, also referred to as a bone conduction transducer (BCT). Speaker 125 may be, for example, a vibration transducer or an electroacoustic transducer that produces sound in response to an electrical audio signal input. The frame of HMD 102 may be designed such that when a user wears HMD 102, the speaker 125 contacts the wearer. Alternatively, speaker 125 may be embedded within the frame of HMD 102 and positioned such that, when the HMD 102 is worn, speaker 125 vibrates a portion of the frame that contacts the wearer. In either case, HMD 102 may be configured to send an audio signal to speaker 125, so that vibration of the speaker may be directly or indirectly transferred to the bone structure of the wearer. When the vibrations travel through the bone structure to the bones in the middle ear of the wearer, the wearer can interpret the vibrations provided by BCT 125 as sounds.

Various types of bone-conduction transducers (BCTs) may be implemented, depending upon the particular implementation. Generally, any component that is arranged to vibrate the HMD 102 may be incorporated as a vibration transducer. Yet further it should be understood that an HMD 102 may include a single speaker 125 or multiple speakers. In addition, the location(s) of speaker(s) on the HMD may vary, depending upon the implementation. For example, a speaker may be located proximate to a wearer's temple (as shown), behind the wearer's ear, proximate to the wearer's nose, and/or at any other location where the speaker 125 can vibrate the wearer's bone structure.

FIG. 1B illustrates an alternate view of the wearable computing device illustrated in FIG. 1A. As shown in FIG. 1B, the lens elements 110, 112 may act as display elements. The HMD 102 may include a first projector 128 coupled to an inside surface of the extending side-arm 116 and configured to project a display 130 onto an inside surface of the lens element 112. Additionally or alternatively, a second projector 132 may be coupled to an inside surface of the extending side-arm 114 and configured to project a display 134 onto an inside surface of the lens element 110.

The lens elements 110, 112 may act as a combiner in a light projection system and may include a coating that reflects the light projected onto them from the projectors 128, 132. In some embodiments, a reflective coating may not be used (e.g., when the projectors 128, 132 are scanning laser devices).

In alternative embodiments, other types of display elements may also be used. For example, the lens elements 110, 112 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 104, 106 for driving such a matrix display. Alternatively or additionally, a laser or LED source and scanning system could be used to draw a raster display directly onto the retina of one or more of the user's eyes. Other possibilities exist as well.

FIG. 1C illustrates another wearable computing system according to an example embodiment, which takes the form of an HMD 152. The HMD 152 may include frame elements and side-arms such as those described with respect to FIGS. 1A and 1B. The HMD 152 may additionally include an on-board computing system 154 and an image capture device 156, such as those described with respect to FIGS. 1A and 1B. The image capture device 156 is shown mounted on a frame of the HMD 152. However, the image capture device 156 may be mounted at other positions as well.

As shown in FIG. 1C, the HMD 152 may include a single display 158 which may be coupled to the device. The display 158 may be formed on one of the lens elements of the HMD 152, such as a lens element described with respect to FIGS. 1A and 1B, and may be configured to overlay computer-generated graphics in the user's view of the physical world. The display 158 is shown to be provided in a center of a lens of the HMD 152, however, the display 158 may be provided in other positions, such as for example towards either the upper or lower portions of the wearer's field of view. The display 158 is controllable via the computing system 154 that is coupled to the display 158 via an optical waveguide 160.

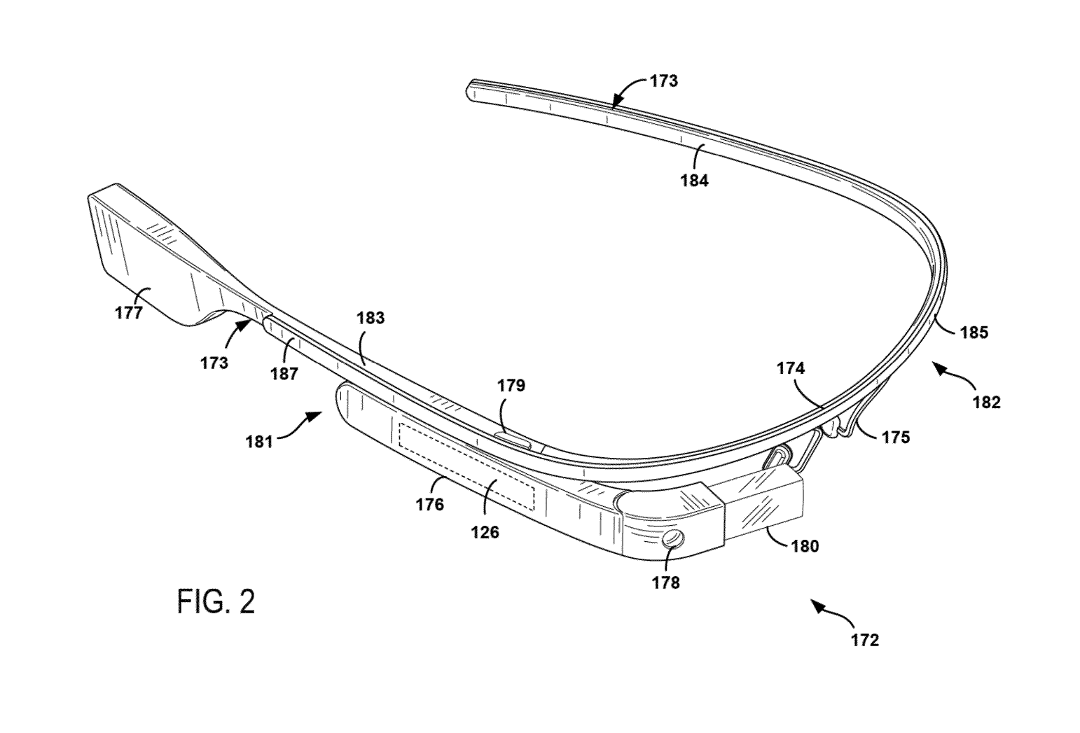

FIG. 1D shows system 200 illustrated within a simplified block diagram a computing device 210 according to an example embodiment. In an example embodiment, device 210 communicates using a communication link 220 (e.g., a wired or wireless connection) to a remote device 230. The device 210 may be any type of device that can receive data and display information corresponding to or associated with the data. For example, the device 210 may be a heads-up display system, such as the head-mounted devices 102, 152, or 172 described with reference to FIGS. 1A to 1C or in FIG. 2-10.

Thus, the device 210 may include a display system 212 comprising a processor 214 and a display 216. The display 210 may be, for example, an optical see-through display, an optical see-around display, or a video see-through display. The processor 214 may receive data from the remote device 230, and configure the data for display on the display 216. The processor 214 may be any type of processor, such as a micro-processor or a digital signal processor, for example.

The device 210 may further include on-board data storage, such as memory 218 coupled to the processor 214. The memory 218 may store software that can be accessed and executed by the processor 214, for example.

The remote device 230 may be any type of computing device or transmitter including a laptop computer, a mobile telephone, or tablet computing device, etc., that is configured to transmit data to the device 210. The remote device 230 and the device 210 may contain hardware to enable the communication link 220, such as processors, transmitters, receivers, antennas, etc.

Further, remote device 230 may take the form of or be implemented in a computing system that is in communication with and configured to perform functions on behalf of client device, such as computing device 210. Such a remote device 230 may receive data from another computing device 210 (e.g., an HMD 102, 152, or 172 or a mobile phone), perform certain processing functions on behalf of the device 210, and then send the resulting data back to device 210. This functionality may be referred to as “cloud” computing.

In FIG. 1D, the communication link 220 is illustrated as a wireless connection; however, wired connections may also be used. For example, the communication link 220 may be a wired serial bus such as a universal serial bus or a parallel bus. A wired connection may be a proprietary connection as well. The communication link 220 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. The remote device 230 may be accessible via the Internet and may include a computing cluster associated with a particular web service (e.g., social-networking, photo sharing, address book, etc.).

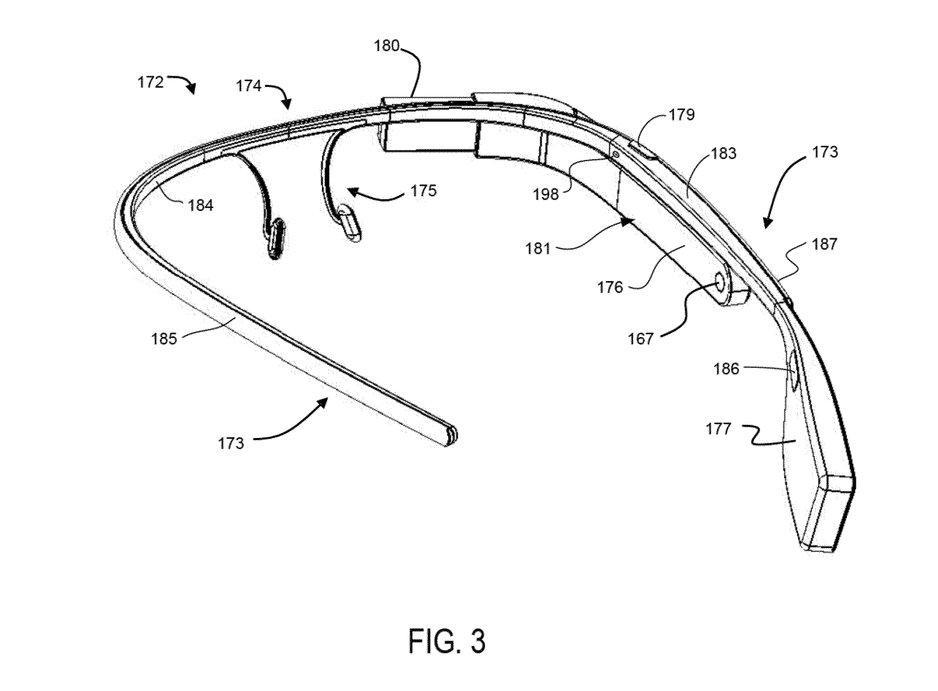

FIGS. 2 and 3 illustrate another wearable computing system according to an example embodiment, which takes the form of a monocular HMD 172. The HMD 172 may include side-arms 173, a center frame support 174, and a bridge portion with nosepiece 175. In the example shown in FIG. 2, the center frame support 174 connects the side-arms 173. The HMD 172 does not include lens-frames containing lens elements. The HMD 172 may additionally include a component housing 176, which may include an on-board computing system (not shown), an image capture device 178, and a button 179 for operating the image capture device 178 (and/or usable for other purposes). Component housing 176 may also include other electrical components and/or may be electrically connected to electrical components at other locations within or on the HMD.

Additionally, component housing 176 can include additional input structures, such as a button 167 (shown in FIG. 3) that can provide additional functionality for HMD 172, including implementing a lock or sleep feature or allowing a user to toggle the power for HMD 172 between on and off states. The button 167 can further include an LED light beneath a surface thereof that can indicate a status of the device, such as on or off, or asleep or awake. The button can be configured such that the light is visible when on, but that the source of the light cannot be seen when the light is off.

The HMD 172 may include a single display 180, which may be coupled to one of the side-arms 173A via the component housing 176. In an example embodiment, the display 180 may be a see-through display, which is made of glass and/or another transparent or translucent material, such that the wearer can see their environment through the display 180. Further, the component housing 176 may include the light sources (not shown) for the display 180 and/or optical elements (not shown) to direct light from the light sources to the display 180. As such, display 180 may include optical features that direct light that is generated by such light sources towards the wearer's eye, when HMD 172 is being worn.

As shown in FIGS. 2 and 3, an end of one of the side arms 173A can be enlarged in the form of an auxiliary housing 177 that can house circuitry and/or a power supply (e.g., removable or rechargeable battery) for HMD 172. In an example, auxiliary housing 177 can be configured and positioned to provide a balancing weight to that of component housing 176. The components within auxiliary housing 177, such as a battery or various control circuitry can be arranged to contribute to a desired weight distribution for HMD 172. HMD 172 also includes a BCT 186 (FIG. 3) positioned on an inner surface of auxiliary housing 177 such that BCT 186 contacts the head of a wearer of HMD 172.

It is also noted that, although the embodiment of FIGS. 2 and 3 shows a component housing 176 that is positioned on side arm 173A such that it is positioned over the right eye of a user when being worn, other similar embodiments are possible in which a mirror-image of component housing 176 can be attached on an opposite side arm 173B to make it positionable over the left eye of the user. Depending on the application of HMD 172 or individual user preferences, it may be desirable to position component housing 176 on a particular side of the user's head. For example, a right-handed person may prefer having the component housing 176 on the right side of her head to make interaction with touch-based input 126 easier. In another example, a person may prefer to have the display 180 over a dominant eye for easier interaction with elements presented on display 180 or over a non-dominant eye to make it easier to shift his focus away from elements presented on display 180 when engaged in other activities.

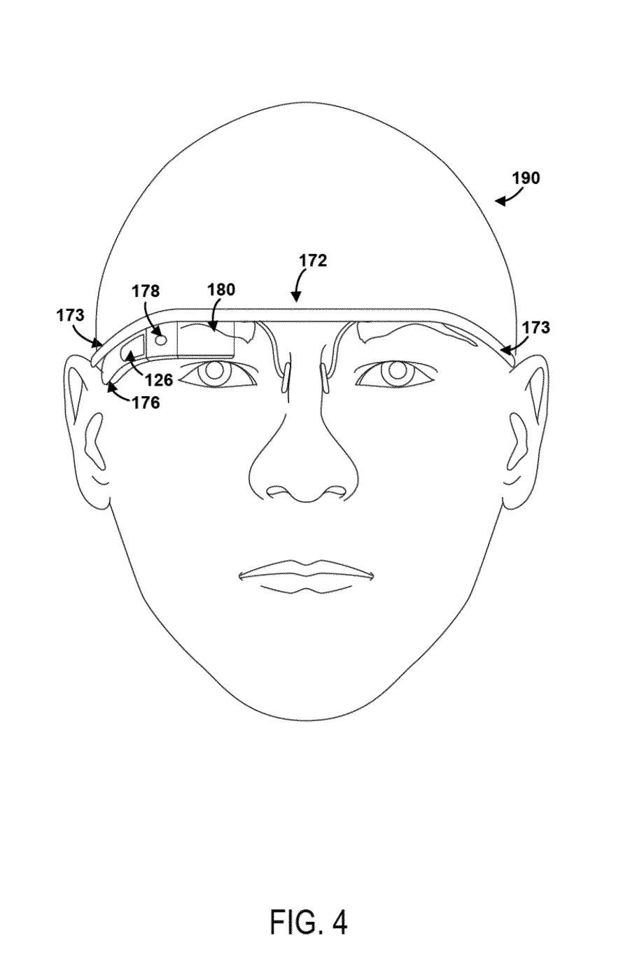

FIGS. 4-6 are simplified illustrations of the HMD 172 shown in FIGS. 2 and 3, being worn by a wearer 190. As shown in FIG. 4, when HMD 172 is worn, BCT 186 is arranged it is located behind the wearer's ear. As such, BCT 186 is not visible from the perspective shown in any of FIGS. 4-6.

In the illustrated example, the display 180 may be arranged such that when HMD 172 is worn, display 180 is positioned in front of or proximate to a user's eye. For example, display 180 may be positioned below the center frame support and above the center of the wearer's eye, as shown in FIG. 4. Further, in the illustrated configuration, display 180 may be offset from the center of the wearer's eye (e.g., so that the center of display 180 is positioned to the right and above of the center of the wearer's eye, from the wearer's perspective).

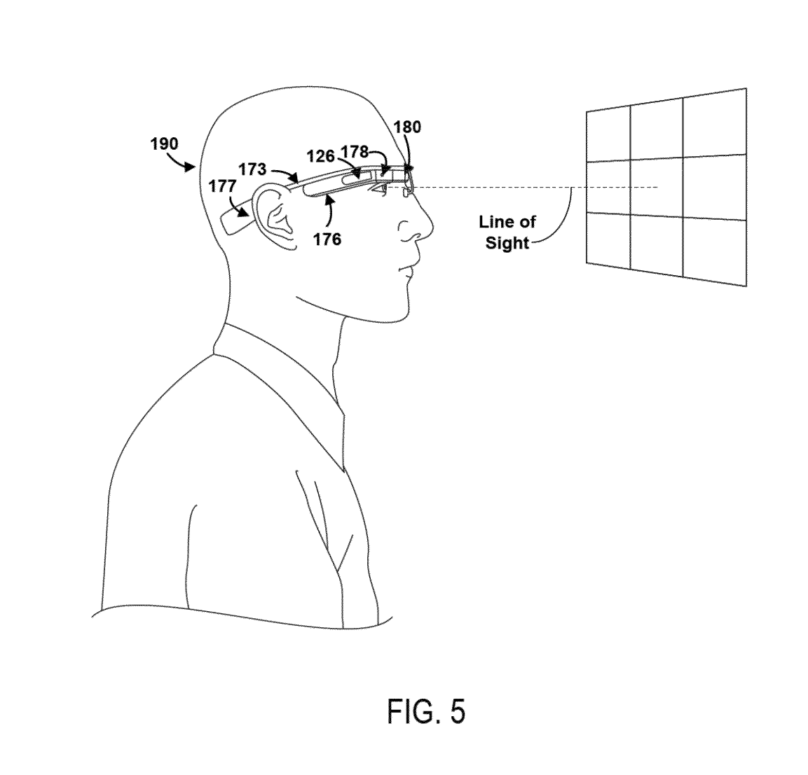

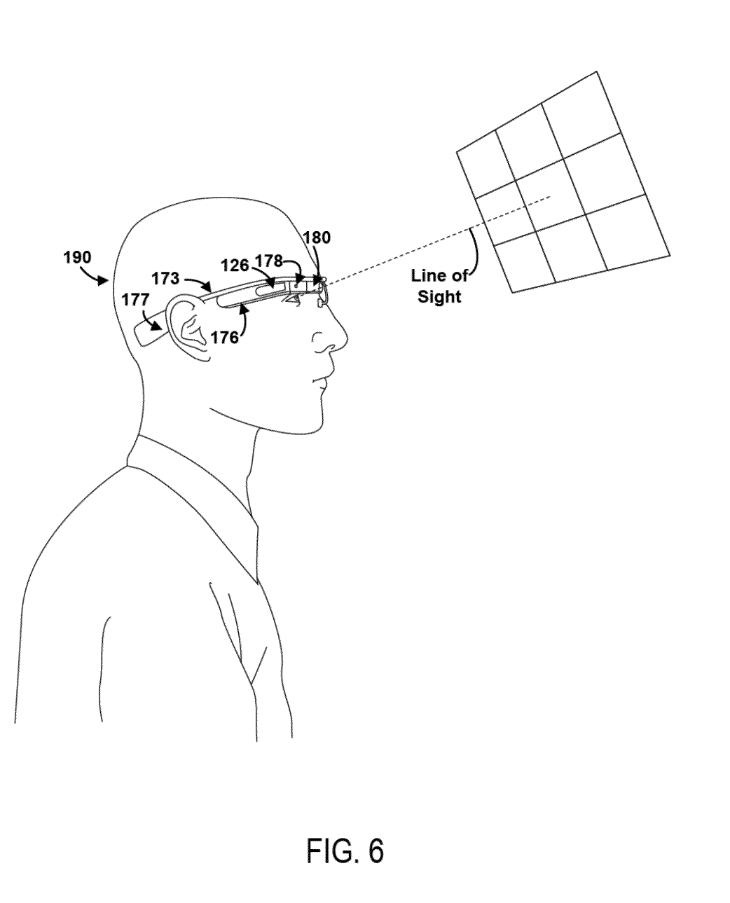

Configured as shown in FIGS. 4-6, display 180 may be located in the periphery of the field of view of the wearer 190, when HMD 172 is worn. Thus, as shown by FIG. 5, when the wearer 190 looks forward, the wearer 190 may see the display 180 with their peripheral vision. As a result, display 180 may be outside the central portion of the wearer's field of view when their eye is facing forward, as it commonly is for many day-to-day activities. Such positioning can facilitate unobstructed eye-to-eye conversations with others and can also generally provide unobstructed viewing and perception of the world within the central portion of the wearer's field of view. Further, when the display 180 is located as shown, the wearer 190 may view the display 180 by, e.g., looking up with their eyes only. This is illustrated as shown in FIG. 6, where the wearer has moved their eyes to look up and align their line of sight with display 180. A wearer might also use the display by tilting their head down and aligning their eye with the display 180.

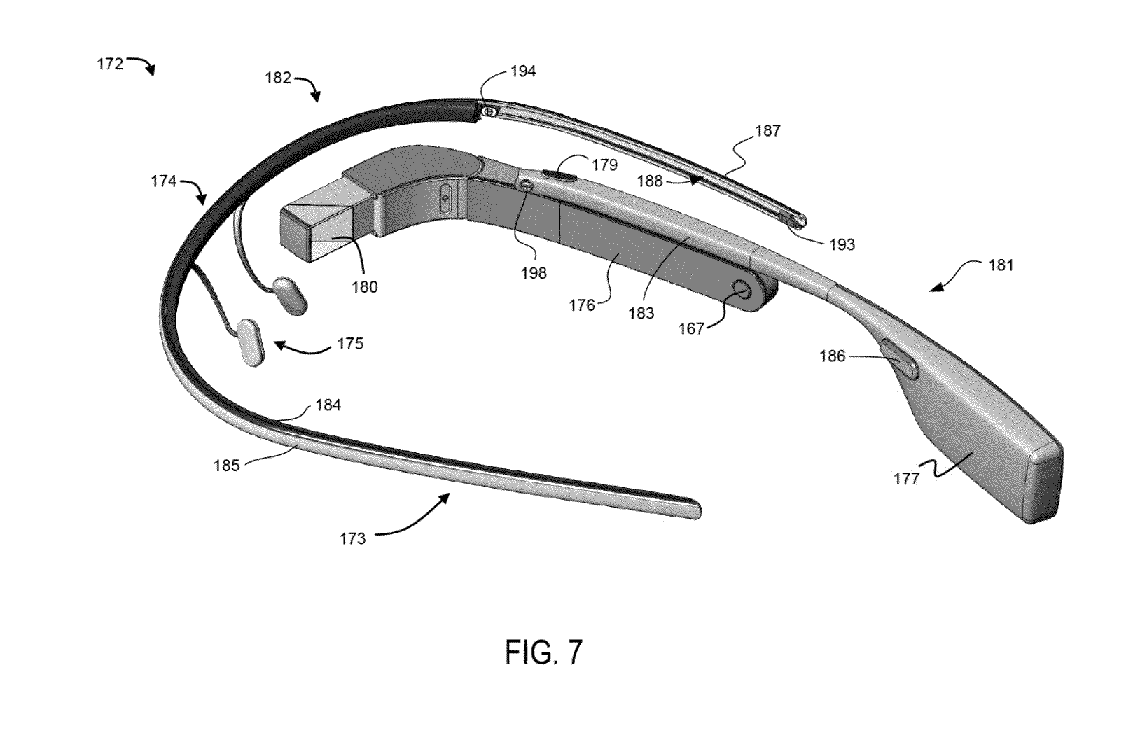

FIGS. 7-10 illustrate an aspect of HMD 172, in which component housing 176 and auxiliary housing 177 can be included in a module 181. Module 181 can be configured to be attachable with and detachable from a separate band 182 such that when the module 181 and band 182 are attached together the HMD 170 can be a single unit that is wearable on the head of a user as described above with respect to FIGS. 4-6. In an example, module 181 can include all or substantially all of the electronic components of HMD 172 such that module 181 can be a fully-functioning unit on its own, with band 182 being provided to allow module 181 to be worn on a user's head.

Both module 181 and band 182 can be structured to present a unitary appearance when assembled together or, in other words, to hide or minimize the visual effect of the separation between such components. Further, module 181 and band 182 can be structured to give an appearance that auxiliary housing 177 extends unitarily from a portion of band 182 to form an uninterrupted side arm 173A and, further, such that component housing 176 is attached beneath band 182 in a separate structure. Other configurations can be used to achieve different visual or appearance characteristics. To achieve the aforementioned visual and appearance characteristics, module 181 can include a connector arm 183 that extends between and connects together component housing 176 and auxiliary housing 177. Connector arm 183 can also include wiring or other circuitry therein to electrically connect devices within component housing 176 with devices within auxiliary housing 177. Connector arm 183 can be configured to extend continuously with an inner portion 184 of band 182 when band 182 and module 181 are assembled together to give the appearance that connector arm 183 is unitary with inner portion 184 of band 182.

As mentioned above, band 182 can be configured to include an inner portion 184 and an outer portion 185. Inner portion 184 can be configured to exhibit a generally compliant or soft characteristic and can include any portions of the band 182 that are intended to contact the user's head. In the particular embodiment shown, inner portion 184 can define a continuous inner surface of band 182. Inner portion 184 can be made of any material that can provide a degree of compliance to enhance the comfort of the fit of band 182 on the user's head while being able to retain its general shape. Acceptable materials include various foams, such as foam rubber, neoprene, natural or synthetic leather, and various fabrics. In an embodiment, inner portion 430 is made of an injection-molded or cast TPE. Inner portion 430 can also be made from various types of Nylon, including for example, Grilamid TR90.

Outer portion 185 of band 182 can be made of a resiliently flexible material such as metal or plastic. In general, the nature of such a material should be such that outer portion 448 can maintain the desired shape for band 182 while allowing flexibility so that band 182 can expand to fit on a user's head while applying a comfortable pressure thereto to help retain HMD 172 on the user's head. Outer portion 185 can be elastically deformable up to a sufficiently high threshold so that the shape of band 182 may not become permanently deformed simply by being worn by a user with a large head. Acceptable materials for outer portion 185 include metals such as aluminum, nickel, titanium (including grade 5 titanium), various steels (including spring steel, stainless steel or the like), or alloys including these and other metals. The thickness of outer portion 185 can be adjusted, depending on the material used, to give the desired flexibility characteristics. As also shown in FIG. 7, nosepiece 175 can be included on band 182 and, in particular, can be attached to or integrally formed with outer portion 185 thereof.

Inner portion 184 of band 182 can be configured to extend only partially along outer portion 185 such that outer portion 185 defines an attachment arm 187 of band 182 that extends beyond inner portion 184. Attachment arm 187 can be configured to extend over a portion of module 181 when band 182 is assembled therewith. As shown in FIG. 7, attachment arm 187 can be configured to be positioned along a portion of connection arm 183 of module 181. As will be described in greater detail below, in such a configuration attachment arm 187 and connector arm 183 can include one or more respective inter-engaging attachment features so that band 182 and module 181 can be attached together therebetween.

Inner portion 184 of band 182 can have a profile such that it at least partially fits within a channel formed by outer portion 185. Inner portion 184 can be sized to fit within a channel 188 formed by a generally U-shaped cross-sectional profile of outer portion 185. Such a channel can extend beyond the end of inner portion 184 such that at least a portion of connector arm 183 can be received within the channel 188. Such a portion of connector arm 183 can be configured to form a snap-fit with channel 188 that can be used to connect band 182 with module 181 or to at least supplement such a connection, either physically or visually, as will be described in greater detail below.

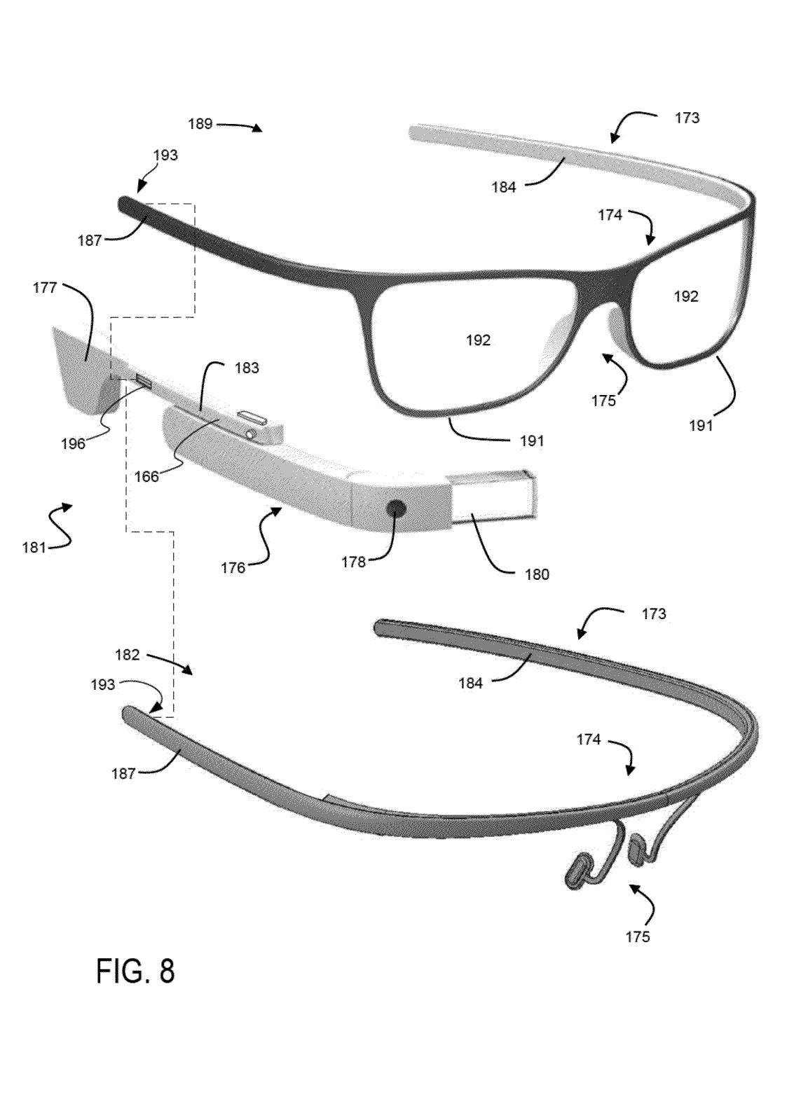

As shown in FIG. 8, the ability to detach band 182 from module 181 can be used to provide a modular configuration for HMD 172 in which other structures can be configured to attach with module 181 in a similar manner to band 182. In an example, a frame structure 189 can replace band 182 in another assembly with module 181. Frame structure 189 can be of a similar construction to band 182 and can include an inner portion 184 and an outer portion 185 with outer portion 185 thereof extending beyond inner portion 184 to define an attachment arm 187 that can be configured to facilitate a removable attachment with module 181 such as with connector arm 183 thereof. Frame structure 189 can further be structured to include a pair of rims 191 integrally formed therewith that can receive respective ones of a pair of lenses 192. The lenses 192 can be in the form of sunglass lenses, prescription eyeglass lenses, prescription sunglass lenses, or the like. Lenses 192 can be captured between portions of outer portion 185 and inner portion 184 within rims 191 or in a more conventional manner such as by attachment with a unitary rim structure.

As shown in FIG. 8, band 182 and frame structure 189 can be used interchangeably with module 181 by a wearer. Other structures can also be used in place of band 182 and/or frame structure 189 in connection with module 181. For example, structures similar to band 182 can be used with module 181 that are designed to connect with module 181 in a similar way to band 182 and can position display 180 in a similar manner with respect to the user's eye as band 182 does. Such structures, however, can vary in shape such that their particular fit with the user's head is different, for example, or such that they exhibit different visual characteristics. In a further example, such a structure can be made without the separate inner 184 and outer 185 portions included in band 182, as described above. Similarly, other structures similar to frame structure 189 can be used with module 181, such as those that provide a different fit or different visual appearance to the frame structure 189 shown and described herein. In various examples, components similar to band 182 but of different sizes, colors or other configurations can be provided for attachment with module 181. Similarly components similar to frame structure 189 can be provided in different sizes, shapes, styles or colors for use with module 181. In a commercial setting modules 181 and various bands 182 and/or frame structures 189 can be packaged and sold separately to allow consumers to configure various final HMD devices 172 according to their own taste or preference. In some instances, bands 182 or frame structures 189 can be sold by various third parties or the like. In another example, an HMD 172 consisting of a module 181 and band 182 as shown herein can be sold attached together in single unit, with the consumer having the ability to swap out the included band 182 for another band or frame structure.

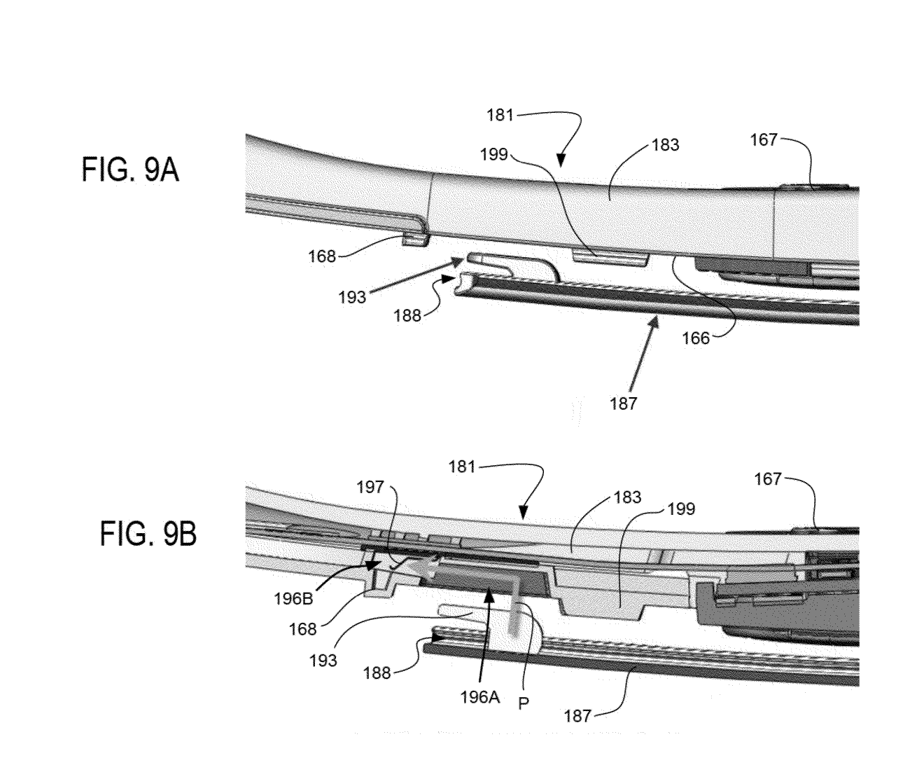

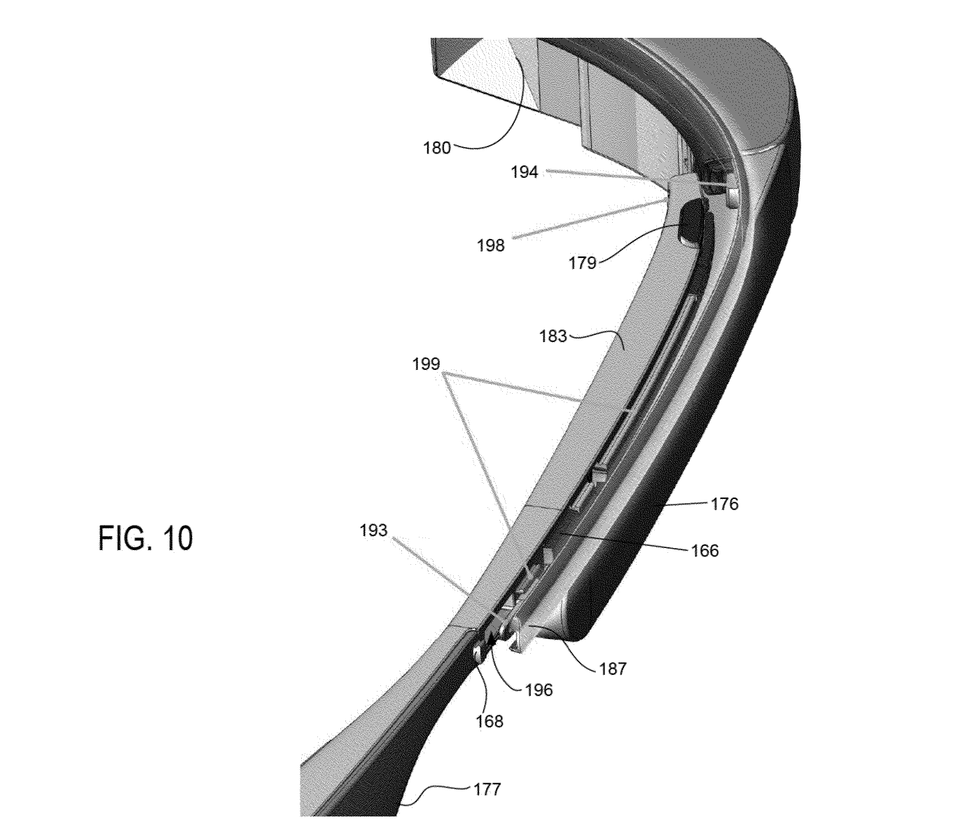

FIG. 7, as well as FIGS. 9 and 10 show an example of features that can be included in module 181 and band 182 (or another similar structure such as frame 189) to attach the two components together, as described above. As shown in FIG. 7, band 182 can include a hook 193 that extends outwardly from channel 188 and is positioned near the end of attachment arm 187. Band 182 can also include a threaded hole 194 positioned within channel 188 on attachment arm 187 opposite hook 193. Module 181 includes a screw 198 that extends therethrough and is positioned to align with threaded hole 194 when module 181 is positioned for attachment with band 182. Screw 198 can be configured with module 181 to form a “captive screw” arrangement such that screw 198 is retained with module 181 whether or not it is assembled within hole 194 by providing an elongated threadless shank portion adjacent the screw head and by positioning the screw 198 within a hole that is larger than the shank but narrower than either the head or the threads of the screw.

As shown in FIGS. 9A and 9B, module 181 can include a slot therein configured to align with and receive hook 193 therein. The slot can include a portion 196A that is open on a face, such as outer face 166 of connector arm 183 along a portion thereof. The slot can further include a closed portion 196B that is in communication with open portion 196A but is closed relative to the face 166 of connector arm 183. In this configuration, slot 196 can receive hook 193 therein by alignment of hook 193 with open portion 196A. To receive hook 193, open portion 196A can be sized to be larger than hook 193 itself to provide room for hook 193 with additional space therearound to reduce the amount of precision needed from the user to assemble hook 193 into open portion 196A. Hook 193 can then be moved into slot 196 along path P shown in FIG. 9B and then slid such that a portion thereof is disposed within closed portion 196B. In this position, hook 193 can retain band 182 against module 181.

In an example, both hook 193 and closed portion 196B of slot 196 can include mating angled surfaces. As shown in FIG. 10, the angled surface 164 of the hook can contact and translate along the angled surface 162 of slot 196 when hook 193 is assembled therewith. The angle of the surfaces 162,164 can be such that a wedging action occurs as hook 193 is moved farther into closed portion 196B, attachment arm 187 is drawn into connector arm 183. This can create pressure therebetween to help maintain the components in close connection when module 181 is attached to band 182. Module 181 can further include a projection 168 that extends outwardly therefrom in a position such that projection 168 fits within the end of channel 188 when hook 193 is positioned as such within slot 196. This can augment the attachment between band 182 and module 181 and/or can provide further visual continuity between structures when attached together.

A spring 197 can be positioned within closed portion 196B of slot 196 as shown in FIG. 9b. In such an arrangement, spring 197 can be configured to provide feedback to the user when hook 193 is appropriately assembled within slot 196 and can further help provide a secure fit therebetween while allowing slot 196 to be oversized in depth relative to hook 193 to make the two features easier to assemble together by allowing hook 193 to enter slot 196 at an angle.

Slot 190 can be positioned on connector arm 183 opposite screw 198 such that all features can simultaneously align to cooperatively attach module 181 and band 182 together. In such a manner, when hook is positioned within slot 196, as described above, screw 198 can be screwed into threaded hole 194 to secure band 182 and module 181 together at that point and to further restrict relative sliding or translational movement between band 182 and module 181 so that hook 193 is retained within slot 196, and in particular such that a portion thereof is positioned within closed portion 196B of slot 196. Such an arrangement can provide a secure attachment between band 182 and module 181 with a single feature to be actuated by the user. Further, by including multiple points of attachment between band 182 and module 181, the attachment can be more robust and resistant to movement therealong, in particular any bending movement along side arm 173.

As discussed above with respect to FIG. 8, module 181 can include one or more snap features 199 thereon that can be configured to engage with a corresponding portion of band 182. In the example shown in FIG. 10, such snap features 199 can be positioned on outer face 166 of connector arm 183 so as to extend between slot 196 and threaded hole 194 and to align with channel 188 of the outer portion 185 of band 182. Snap features 199 can be configured to engage with channel 188, such as by configuring channel 188 and snap features 199 with inter-engaging projections and undercuts.

In an example, channel 188 (see FIGS. 9A-B) can include flanges or other projections extending inwardly from channel 188 at the edges thereof and snap features 199 can be T-shaped or the like to provide an interference fit with channel 188 when received therein. This type of fit can be facilitated by compliance in either band 182, snap features 199, or both. For example, band 188 can be structured such that it can flex to allow channel 188 to expand to accept snap features 199. In another example, snap features 199 can be compressible to allow them to be pressed into channel 188. As discussed above, the inner portion 184 of band 182 can be of a compliant or compressible material such as Nylon or the like. Module 181 can be at least covered or coated with a similar material to give visual continuity with inner portion 184 of band 182. Further, snap features 199 can be of or coated with such a material to give a degree of compliance to facilitate the snap-fit arrangement with channel 188.

Such a snap-fit arrangement can help to retain portions of module 181 between slot 196 and screw 198 in contact with band 182. In the example shown in FIGS. 7-10, this can include retaining portions of connector arm 183 between slot 196 and screw 198 in contact with the attachment arm 187 defined by outer portion 185 of band 182. This can provide visual enhancement for the connection between band 182 and module 181 by minimizing any gap between components and by contributing to the unitary visual appearance between components, as discussed above. This snap-fit arrangement can also physically enhance the connection between module 181 and band 182 by providing additional points of connection therebetween to make the overall connection more robust. It can also help maintain a temporary connection between module 181 and band 182 after hook 193 has been positioned within slot 196 before screw 198 is threaded into hole 194 to make assembly easier for a user.

In other examples, such a snap fit can be made to be strong enough to allow for module 181 to be assembled with band 182 without the use of a screw 198 or aligning threaded hole 194. In another example, another press- or snap-fit feature can replace the screw 198 and hole 194 combination described above in generally the same location thereof.

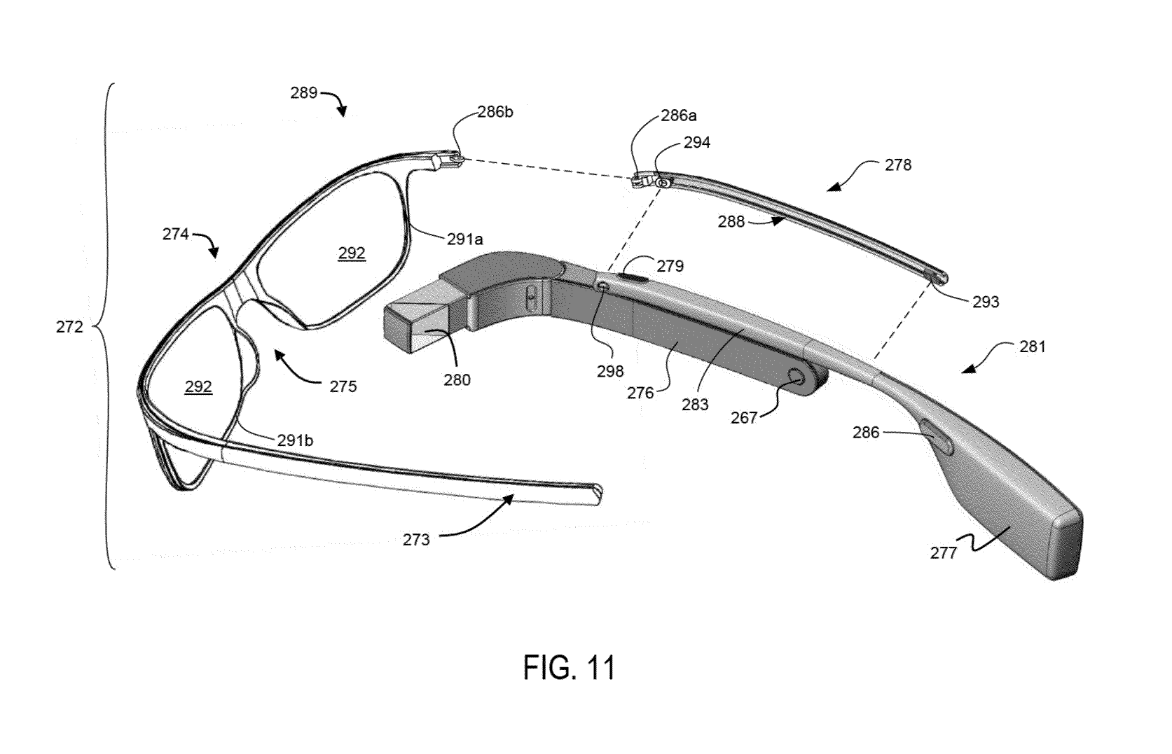

FIG. 11 shows another example of an HMD system 272 that can include a module 281 that is similar to the module 181 that is discussed above with respect to FIGS. 7-10. HMD system 272 can incorporate an adaptor arm 278 that is configured to attach with module 281 in a similar manner as the attachment arm 187 of band 182. Adaptor arm 278, however, can be configured as a component that is not an extension of another element such as a band (e.g., band 182). Instead, adaptor arm 278 can include an attachment feature at an end opposite hook 293 that can be used to attach adaptor arm 278 to a feature of another head-wearable item. In the example shown in FIG. 11, adaptor arm 278 includes a first hinge portion 286a on an end thereof. First hinge portion 286a can be used to attach adaptor arm 278 to a glasses frame 289 that includes a second hinge portion 286b. At the same time, adaptor arm 278 can be attached with module 281 such that the assembled HMD system 272 is wearable on the head of a user in a similar manner to the HMD 172 of FIG. 8 with the glasses frame 189 of that example affixed with module 181.

In an example application, the HMD system 272 incorporating adaptor arm 278 can allow for flexibility in the type, size, style, etc. of glasses frame 289 used in the system 272. That is, adaptor arm 278 can be provided that can be attached with existing or specially-designed glasses frames 289, for example, made by various eyewear manufacturers or already owned by individuals. Adaptor arms 278 of different types or configurations can be provided or sold to match different styles of eyeglass frames or to include various types of hinges or other attachment structures. In one example, one type of adaptor arm 278 can include half of a standard barrel-type hinge, as shown in FIG. 11, while another can include half of a spring-loaded flexible hinge sometimes found in eyewear. In another example, an adaptor arm can be provided with screw hole 293 and hook 293 included thereon, but without a hinge portion 286a. Instead an area can be provided for a user or a manufacturer to attach a hinge portion of its own design.

Still further, adaptor arms 278 of any configuration or of various specific configurations can be provided with other related components and/or data (such as blueprints or computer-readable CAD data) in the form of a hardware developer kit (“HDK”). Such an HDK can give manufacturers or users supplies and information to help them adapt their own glasses frames to properly work with a module 281 and adaptor arm 278 according to the general principles discussed above, such as in FIGS. 1A-D and 4-6. Such information can also be used to design glasses frames that are specifically adapted to work with module 281 and adaptor arm 278. In an example application, a manufacturer can purchase an HDK including an adaptor arm 278 and use the information provided therein to design a glasses frame 289 that it can then assemble with adaptor arm 278 for sale in a unit that can then be purchased by a user for assembly and wear/use with his own module 281.

Although the description herein has been made with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the appended claims.

1. A wearable device assembly, comprising:
a device module including a component housing having a display configured to present information to the user, an auxiliary housing unit remote from the component housing, and a connecting member extending between the housing unit and the auxiliary housing unit, the connecting member including a first attachment structure on a surface thereof; and
a head retention structure including a center support with a nosepiece extending therefrom, a first side arm extending from the center frame support on a first side thereof, and an attachment arm extending from the center support on a second side thereof, the attachment arm including a second attachment structure that is configured to mate with the first attachment structure;
wherein the device module and the head retention structure are configured for releasable assembly together by removably attaching the first attachment feature with the second attachment feature, and wherein when assembled together, the device assembly is wearable on the head of the user with the module positioned on a first side of the head with the display adjacent an eye of the user, the side arm positioned on a second side of the head, and the nosepiece contacting the nose of the user.

2. The wearable device assembly of claim 1, wherein the attachment arm extends along at least a portion of connecting member when the device module and the retention structure are assembled together.

3. The wearable device assembly of claim 1, wherein:
the second attachment structure includes a hook with a portion thereof extending inwardly with respect to the attachment arm and a second portion extending in a direction generally parallel to the attachment arm; and
the first attachment feature includes a slot having a first portion open to the surface of the connecting member and configured to receive the hook therein and a second portion in communication with the first portion and closed relative to the surface of the connecting member, the second portion being configured to retain the second portion of the hook within the slot.

4. The wearable device assembly of claim 3, wherein the second attachment structure further includes a threaded hole positioned along the attachment arm at a location spaced apart from the hook, and wherein the first attachment structure includes a screw receivable in hole and configured to be aligned therewith when the hook is received within slot.

5. The wearable device assembly of claim 4, wherein when screw is received within the threaded hole, it restricts movement of the attachment arm relative to the connecting member such that the second portion of the hook remains within the second portion of the slot.

6. The wearable device assembly of claim 5, wherein the second attachment structure further includes a channel defined along the attachment arm, and wherein the first attachment structure includes a snap feature positioned between the slot and the screw and configured to engage with the channel of the second attachment structure.

7. The wearable device assembly of claim 3, wherein the hook and the slot include respective mating angled surfaces such that when the second portion of the hook is moved into the second portion of the slot, pressure is applied between the attachment arm and the connecting member.

8. The wearable device assembly of claim 3, wherein the first attachment feature further includes a spring positioned in the second portion of the slot, wherein the spring is configured to provide feedback to a user when the hook is properly positioned within the slot.

9. The wearable device assembly of claim 1, wherein the second attachment structure includes a channel defined along the attachment arm, and wherein the first attachment structure includes a snap feature configured to engage with the channel of the second attachment structure to at least partially attach the module and the retention structure.

10. The wearable device assembly of claim 1, wherein the side arm of the retention structure is a first side arm, and wherein when the device module and the retention structure are attached together, the attachment arm of the retention structure and the connecting member and the auxiliary housing visually appear as a continuous second side arm opposite the first side arm.

11. The wearable device assembly of claim 1, wherein the device module is configured to carry out any electronic functions of the wearable device assembly without being assembled with the retention structure.

12. The assembly of claim 1, wherein the retention structure includes a compliant inner portion and a resilient outer portion, the resilient outer portion being a substantially uniform structure that defines an outer surface of the first side arm and extends from the second end of the center support to define the attachment arm.

13. The wearable device assembly of claim 12, wherein the inner portion of band does not extend along the attachment arm, and wherein the connecting member extends substantially continuously from the inner portion of the band when the device module and retention structure are assembled together.

14. The assembly of claim 1, wherein the retention member includes a first lens and a second lens affixed to the center support thereof, the first and second lenses being positionable over respective eyes of the user, and wherein when the retention member and module are assembled the display is supportable by the component housing on a side of the lens opposite one of the user's eyes.

15. A retention member for use with a personal display module that includes a display configured to present information to a user, a housing unit remote from the display, and a connecting member extending at least partially between the housing unit and the display, the retention member comprising:
a center support;
a first side arm extending from the center support on a first side thereof; and
an attachment arm extending from the center support on a second side thereof, the attachment arm including a first attachment structure configured to releasably attach with a second attachment structure included along a surface of the connecting member of the personal display module;
wherein the releasable attachment between the first attachment structure and the second attachment structure removably secures the retention member to the personal display module such that the resulting assembly is wearable on the head of a user with the display of the module positioned adjacent an eye of the user.

16. The retention member of claim 15, wherein the center support, attachment arm, and first side arm are portions of a band configured to continuously extend a general “U” shape.

17. The retention member of claim 16, wherein the band includes a nosepiece extending from the center support thereof, wherein the nosepiece is configured to rest on the nose of the user when an assembly of the retention member and the personal display module are worn by the user.

18. The retention member of claim 15, further including includes a first lens and a second lens, wherein the center support defines a first lens retention structure and a second lens retention structure and a bridge between the first and second lens retention structures, and wherein the first and second lenses are respectively retained within the first and second lens retention structures.

19. The retention member of claim 15, wherein the first attachment structure includes a hook with a first portion thereof extending inwardly with respect to the attachment arm and a second portion thereof extending in a direction generally parallel to the attachment arm.

20. The retention member of claim 19, wherein the first attachment structure further includes threaded hole positioned along the attachment arm at a location spaced apart from the hook.

21. The retention member of claim 19, wherein the second attachment structure includes a channel defined along the attachment arm configured for providing a snap-fit attachment with a mating portion of the connecting member.

22. The retention member of claim 15, further including a compliant inner portion and a resilient outer portion, the resilient outer portion being a substantially uniform structure that defines an outer surface of the first side and center and further defines the attachment arm.

23. A personal display module, comprising:
a component housing having a display configured to present information to the user;
an auxiliary housing unit remote from the component housing; and
a connecting member extending between the housing unit and the extension arm, the connecting member including a first attachment structure on a surface thereof;
wherein the personal display module is configured to removably attach with a retention member at the first attachment structure so as to be wearable on the head of the user with the module positioned on a first side of the head with the display adjacent an eye of the user.

24. The personal display module of claim 23, wherein the first attachment structure includes a slot having a first portion open to the surface of the connecting member and configured to receive the hook therein and a second portion in communication with the first portion and closed relative to the surface of the connecting member.

25. The wearable device assembly of claim 24, wherein the first attachment structure includes a through hole retaining a screw therein, the through hole being positioned along the connecting member remote from the slot.

26. The wearable device assembly of claim 23, wherein the first attachment structure includes a snap feature positioned between the slot and the screw and configured to engage with the channel of the second attachment structure.

27. An adaptor element for use with a personal display module that includes a display configured to present information to a user, a housing unit remote from the display, and a connecting member extending at least partially between the housing unit and the display, the retention member comprising:
a body extending between a first end and a second end and defining an inside surface and an outside surface;
a first attachment structure on the inside surface of the body positioned between the first and second ends and configured to releasably attach with a second attachment structure included along a surface of the connecting member of the personal display module; and
a connection element affixed to the body adjacent the first end thereof, then connection element being configured to connect the adaptor element with an external structure to provide a head-wearable device assembly, at least when the first attachment structure is attached with the second attachment structure.

28. The adaptor element of claim 27, wherein the connection element includes a portion of a hinge.

29. The adaptor of claim 28, wherein the first attachment structure includes a hook attached to the inside surface of the body adjacent the second end thereof and a threaded hole positioned along the inside surface of the body at a location spaced apart from the hook.
